(19) United States
(12) Patent Application Publication
(10) Pub. No.: US 2008/0035361 A1
(43) Pub. Date: Feb. 14, 2008

(54) Electric hand-held power tool

(76) Inventor: Zhi Zhang, Century Modern City (CN)

Correspondence Address: MCDERMOTT, WILL & EMERY LLP, 227 WEST MONROE STREET, SUITE 4400, CHICAGO, IL, 60606-5096, US

(21) Appl. No.: 11/890,558

(22) Filed: Aug. 7, 2007

(30) Foreign Application Priority Data
Aug. 9, 2006 (CN) 200620076244.9

(51) Int. Cl. B23B 39/00

(52) U.S. Cl. 173/217

(57) ABSTRACT

The present invention provides an electric handheld power tool, which comprises a tool housing, a motor mounted within the tool housing, a fan, and an output mechanism driven by the motor; a cover of the motor has an air inlet and an air outlet, and the motor housing has at least two slots which are angularly offset with respect to the air outlet, and at least one rib extending outwardly from the motor cover. Since the slots of the housing are offset with respect to the air outlet of the motor cover in an angular direction, electric sparks that may be generated in the motor are substantially isolated and constrained by the housing and not allowed to flow to outside of the housing. Therefore, potential danger is avoided and operational safety is enhanced. At the same time, the cavity between the motor cover and the tool housing is divided by the rib such that circulation of the air in the space is prevented. The air driven from inside of the motor cover is totally exhausted from the slots of the tool housing and thus the efficiency of the heating dissipation of the motor is enhanced.

This application claims priority under 35 U.S.C. 119 to CN 200620076244.9 filed Aug. 9, 2006, and is hereby incorporated by reference.

### BACKGROUND OF THE INVENTION

The present invention relates to an electric hand-held power tool, specifically to a power tool with air-cooling device.

A power tool commonly comprises a motor contained in a cover, and a transmission device driven by the motor. The motor cover usually has an air outlet and an air intake. And the housing of the power tool has a window which substantially aligns with the air outlet of the cover for enhancing cooling efficiency. During operation, cool air is drawn by the motor fan into the cover from the intake with heated air exhausted from the window of the housing through the outlet of the motor cover, which cools the motor.

However, with the structure that the window of the housing substantially aligns with the air outlet of the motor cover as disclosed hereinabove, during the operation of the power tool, electrical sparks generated during high-speed rotating of the motor tends to be drawn by the airflow to the outside of the housing, which creates a potential safety problem.

In consideration of this, solutions were brought out, one of which is to offset the air outlet of the cover from the window of the housing so as to keep and isolate the electric spark within the housing. However, there is a disadvantage that since the space between the cover and the housing are circumferentially connected, such that the air exhausted from the motor cover is cycled inside the housing, which reduces the air discharged from the window of the housing and results in low efficiency of heat dissipation.

### SUMMARY OF THE INVENTION

The object of this invention is to overcome current technical problems and provide an improved hand-held power tool which can prevent the electric spark from diffusing to outside of the housing without reduction of the heat dissipation.

In order to obtain the object, the electrical hand-held power tool of the present invention comprises a tool housing, a motor mounted within the tool housing, a fan, and an output mechanism driven by the motor; a cover of the motor has an air inlet and an air outlet, and the motor housing has at least two slots which are angularly offset with respect to the air outlet, and at least one rib is defined between at least two slots and is mounted on the motor cover.

When the motor rotates, air is drawn by the fan to flow out of the motor cover from the air outlet and exhausts through the slots of the tool housing. Since the slots of the housing are offset with respect to the air outlet of the motor cover in an angular direction, electric sparks that may be generated in the motor are substantially isolated by the housing and not able to flow to outside of the housing. Therefore potential danger is avoided and operational safety is enhanced. At the same time, the circumferential space between the motor cover and the tool housing is divided by the rib such that circulation of the air in the space is prevented. The air driven from inside of the motor cover is totally exhausted from the slots of the tool housing, and thus the efficiency of the heating dissipation of the motor is enhanced.

With such an improvement of the present invention, potential harm resulting from leakage of the electrical spark is avoided, and cooling efficiency of the power tool is improved.

### BRIEF DESCRIPTION OF THE DRAWINGS

The invention will be described in detail in conjunction with the accompanying drawings, wherein

FIG. 1 is a perspective view of one embodiment of the invention.

FIG. 2 is a section view along B-B of FIG. 1.

### DETAILED DESCRIPTION OF THE PREFERRED EMBODIMENTS

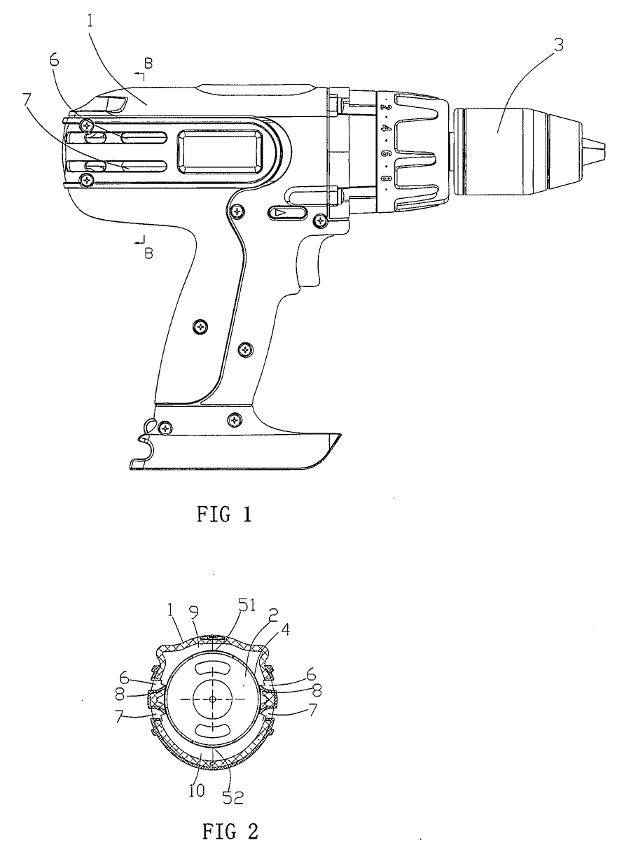

Referring to FIGS. 1 and 2, a handheld power drill as an embodiment of the present invention includes a housing 1, a motor 2 mounted in the housing 1, and a drill chuck 3 driven by the motor 2. The motor 2 is contained in a cover 4 which has air inlets (not shown), an upper air outlet 51 and a lower air outlet 52. The housing 1 is formed by joining two symmetric half shells, each of which has an elongated upper slot 6 and an elongated lower slot 7 close to each other and adjacent to the motor 2. Additionally, the housing includes air inlets 5a, 5b formed behind upper slot 6 and lower slot 7, respectively.

As shown in FIG. 2, the upper slots 6a, 6b and lower slots 7a, 7b are angularly offset, preferably 90°, from the upper air outlet 51 and lower air outlet 52, respectively. Ribs 8a, 8b extend outward from the motor cover 4. Rib 8a is positioned between upper slot 6a and lower slot 7a, and rib 8b is positioned between upper slot 6b and lower slot 7b. A first airflow cavity 9 is formed between the housing 1, motor cover 4, and ribs 8a, 8b. Additionally, a second airflow cavity 10 is formed between the housing 1, motor cover 4, and ribs 8a, 8b. Thus, the ribs 8a, 8b represent the peripheral portions of the first cavity 9 and second cavity 10. The upper slots 6a, 6b are in fluid communication with first cavity 9 to vent the cavity 9. Similarly, the lower slots 7a, 7b are in fluid communication with the second cavity 10 to vent the cavity 10.

When the motor 2 rotates clockwise, air driven by a fan (not shown) flows out of the motor cover 4 through the upper air outlet 51 and the lower air outlet 52 in a clockwise direction. The air exhausted from the upper air outlet 51 flows through the first airflow cavity 9 and exits from the upper slot 6b of the housing I as shown by airflow path 12. Similarly, the air exhausted from the lower air outlet 52 flows through the second airflow cavity 10 and exits from the lower slot 7a of the housing I as shown by airflow path 14. Ribs 8a and 8b further direct the flow through cavity 9 and cavity 10 for discharge through slots 6b and 7a, respectively. Conversely, when the motor rotates counterclockwise, air exhausted from the motor 2 flows out of the motor cover 4 through the upper air outlet 51 and the lower air outlet 52 in a counterclockwise direction. The air exhausted from the upper air outlet 51 flows through the first airflow cavity 9 and exits from the upper slot 6a of the housing 1. Similarly, the air exhausted from the lower air outlet 52 flows through the second airflow cavity 10 and exists from the lower slot 7b of the housing 1. Ribs 8a and 8b further direct the flow of air through cavity 9 and cavity 10 for discharge through slots 6a and 7b, respectively. Thus, the discharge of exhaust air from motor 2 has a direct outlet path and is not impeded, which increases the operating efficiency of the motor 2.

The ribs 8a, 8b and the slots 6a, 6b, 7a, 7b of the housing 1 are substantially 90° offset from the air outlets 51, 52 of the motor cover in an angular direction, and therefore electric sparks generated during operation of the motor are substantially isolated within the housing, namely within cavities 9 and 10. Consequently, sparks are constrained within the housing 1. Therefore potential danger is avoided and operational safety is enhanced.

The invention is not limited to the embodiment described hereinabove. For example, electric-powered tool may not only be a drill, but also can be an electrical hammer, an electrical saw, etc. Many other modifications and variations of the preferred embodiment will be apparent and may be made without departing from the spirit and the scope of the invention as defined in the following claims.

We claim:

1. A power tool comprising:
a housing having a first upper slot and a second upper slot;
a motor mounted within said housing, the motor having a cover with an air outlet wherein the air outlet is offset from the first and second upper slots; and,
a first rib and a second rib extending outward from said cover, wherein the first rib is positioned below the first upper slot and the second rib is positioned below the second upper slot.

2. The power tool of claim 1, wherein said upper slots are offset angularly from said air outlet.

3. The power tool of claim 2, wherein said upper slots offset approximately 90 degrees from said air outlet.

4. The power tool of claim 1, wherein said housing comprises two symmetric half shells, the first upper slot positioned in one of the half shells, and the second upper slot positioned in the other of the half shells.

5. The power tool of claim 1, wherein said housing further comprises a first lower slot adjacent the first upper slot and a second lower slot adjacent the second upper slot.

6. The power tool of claim 5, wherein said first rib is positioned between said first upper slot and said first lower slot, and said second rib is positioned between said second upper slot and said second lower slot.

7. The power tool of claim 1, wherein said cover comprises two air outlets on opposite sides of the motor.

8. A power tool comprising:
a housing having a first pair of slots and a second pair of slots;
a motor residing within said housing, the motor having a cover with an upper air outlet and a lower air outlet, wherein the upper air outlet and lower air outlet are offset from the first pair of slots and the second pair of slots;
a first rib and second rib extending outward from said cover, wherein the first rib is positioned between the first pair of slots and the second rib is positioned between the second pair of slots; and,
wherein during operation, the first rib and second rib direct an exhaust airflow from the upper air outlet and the lower air outlet out of the first pair of slots and second pair of slots.

9. The power tool of claim 8, wherein said first pair of slots and said second pair of slots are angularly offset from said upper air outlet and lower air outlet.

10. The power tool of claim 9, wherein said first pair of slots and said second pair of slots are angularly offset approximately 90 degrees from said upper air outlet and said lower air outlet.

11. The power tool of claim 8, wherein said housing comprises two symmetric half shells, the first pair of slots positioned in one of the half shells, and the second pair of slots positioned in the other of the half shells.

12. The power tool of claim 8, wherein the first rib and second rib are in an opposed relationship of approximately 180 degrees.

13. The power tool of claim 8, wherein one of the slots in first pair of slots and one of the slots in the second pair of slots vent the housing during clockwise rotation of the motor.

14. The power tool of claim 13, wherein the other of the slots in the first pair of slots and the other of the slots in the second pair of slots vent the housing during counterclockwise rotation of the motor.

15. The power tool of claim 8, wherein said upper air outlet and said lower air outlet reside on opposite sides of the motor.

16. A power tool comprising:
a housing having a first upper slot, a second upper slot, a first lower slot, and a second lower slot;
a motor residing within said housing, the motor having a cover with an upper air outlet residing between the first and second upper slots, the cover further having a lower air outlet residing between the first and second lower slots;
a first rib extending outward from said cover and between the first upper slot and the first lower slot, and a second rib extending outward from said cover and between the second upper slot and the second lower slot;
a first cavity formed between the housing and the motor cover, wherein the first and second ribs bound the periphery of the first cavity; and,
a second cavity formed between the housing and the motor cover, wherein the first and second ribs bound the periphery of the second cavity.

17. The power tool of claim 16, wherein the first upper slot vents the first cavity and the second lower slot vents the second cavity during clockwise rotation of the motor

18. The power tool of claim 17, wherein the second upper slot vents the first cavity and the first lower slot vents the second cavity during counterclockwise rotation of the motor.

19. The power tool of claim 16, wherein the first rib and second rib are in an opposed relationship of approximately 180 degrees.

20. The power tool of claim 19, wherein the first and second upper slots are in fluid communication with the first cavity.

21. The power tool of claim 20, wherein the first and second lower slots are in fluid communication with the second cavity.
